(19) United States
(12) Patent Application Publication
(10) Pub. No.: US 2023/0266063 A1
(43) Pub. Date: Aug. 24, 2023

(54) Lumber Drying Kiln Configurations and Methods

(71) Applicant: S B KILN COATING & MAINTENANCE INC., Rathdrum, ID (US)

(72) Inventors: Marty Stutheit, Rathdrum, ID (US); Lonnie Stutheit, Post Falls, ID (US)

(21) Appl. No.: 18/107,458

(22) Filed: Feb. 8, 2023

Related U.S. Application Data
(63) Continuation-in-part of application No. 15/598,110, filed on May 17, 2017, now abandoned.

(51) Int. Cl. F26B 25/00; F26B 9/02

(52) U.S. Cl. CPC F26B 25/003; F26B 9/02; F26B 2210/16

(57) ABSTRACT

Lumber drying kilns are provided that can include a ceiling member supported by opposing wall members and a pair of complimentary baffles extending vertically from about a junction of the wall and ceiling. Drying kilns are also provided that can include a junction between a wall and a ceiling above material to be dried within the drying kiln and at least one baffle extending vertically along the side of the material to be dried. Methods for retrofitting existing drying kilns are provided that can include extending vertical baffles from about a junction of a wall and ceiling of the drying kiln. Methods for drying material within a drying kiln are also provided that can include placing material to be dried within a drying kiln and drying the material within the kiln while a pair of vertical extending baffles hang along opposing walls of the kiln.

### CROSS REFERENCE TO RELATED APPLICATION

This application is a continuation-in-part of U.S. Pat. Application Serial No. 15/598,110 which was filed May 17, 2017, entitled “Drying Kiln Configurations and Methods”, the entirety of which is incorporated by reference herein.

### TECHNICAL FIELD

The present disclosure relates to material drying kiln configurations and methods. Particular embodiments provide wood or lumber drying kiln configurations and methods.

### BACKGROUND

Drying kilns are used to dry lumber, particularly, at as rapid a rate as practical while damaging as few pieces of lumber as possible. These drying kilns typically are formed as part of bays, and these bays have heating units and/or fan units inside these drying kilns. Users of drying kiln processes and methods are searching for ways to improve efficiencies and increase throughput. For example, the more lumber that leaves the kiln after drying that is saleable, the more efficient the kilning. It is desirable for lumber to have a moisture content (MC%) of 19% per the Western Wood Product Association Guidelines for Lumber Drying. The present disclosure provides drying kiln configurations and methods that address some of the shortcomings of the current art of drying kilns and methods. For example, the present disclosure provides methods and/or configurations that can increase the amount of saleable lumber leaving the kiln.

### SUMMARY OF THE DISCLOSURE

Lumber drying kilns are provided that can include a ceiling member supported by opposing wall members and a pair of complimentary baffles extending vertically from about a junction of the wall and ceiling.

Drying kilns are also provided that can include a junction between a wall and a ceiling above material to be dried within the drying kiln and at least one baffle extending vertically along the side of the material to be dried.

Methods for retrofitting existing drying kilns are provided that can include extending vertical baffles from about a junction of a wall and ceiling of the drying kiln.

Methods for drying material within a drying kiln are also provided that can include placing material to be dried within a drying kiln and drying the material within the kiln while a pair of vertical extending baffles hang along opposing walls of the kiln.

Lumber drying kilns are provided that can include: a ceiling member supported by opposing continuous wall members; stacked lumber to be kilned within the kiln, the stacked lumber being under the ceiling member and between the opposing continuous wall members, wherein the stacked lumber is arranged in courses, with each course vertically spaced apart from one another from a top of the stacked lumber to a bottom of the stacked lumber; at least one heating source lateral of the stacked lumber; and at least one rubber baffle lateral of the stacked lumber, the at least one rubber baffle extending vertically from the ceiling between the stacked lumber and at least one of the opposing continuous wall members to at least three courses below the top of the stacked lumber and exposing the heating source to the stacked lumber below the at least third course.

### DRAWINGS

The patent or application file contains at least one drawing executed in color. Copies of this patent or patent application publication with color drawing(s) will be provided by the Office upon request and payment of the necessary fee.

Embodiments of the disclosure are described below with reference to the following accompanying drawings.

FIG. 1 is a drying kiln configuration according to an embodiment of the disclosure.

FIG. 2 is a drying kiln configuration with material to be dried within the kiln according to an embodiment of the disclosure.

FIG. 3 is a drying kiln in process of retrofitting according to an embodiment of the disclosure.

FIG. 4 is a detailed view of a portion of FIG. 2.

FIG. 5 is a detailed view of a portion of FIG. 2.

FIG. 6 is data acquired from lumber kilned according to the configuration of FIG. 7.

FIG. 7 is a picture of a portion of lumber within a kiln in one configuration.

FIG. 8 is data acquired from lumber kilned according to the configuration of FIG. 9.

FIG. 9 is a picture of a portion of lumber within a kiln in another configuration.

FIG. 10 is data acquired from lumber kilned according to the configuration of FIG. 11.

FIG. 11 is a picture of a portion of lumber within a kiln configured in accordance with embodiments of the disclosure.

### DESCRIPTION

This disclosure is submitted in furtherance of the constitutional purposes of the U.S. Patent Laws “to promote the progress of science and useful arts” (Article 1, Section 8).

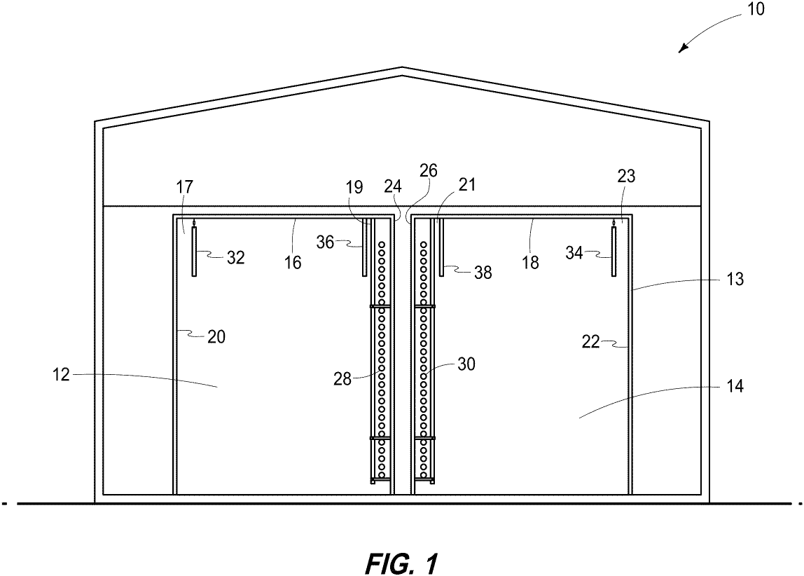

The present disclosure will be described with reference to FIGS. 1-11. Referring first to FIG. 1, a drying house 10 is depicted as an example drying house. This drying house can include two bays; bay 12 and bay 14. Typically, the bays have ceilings 16 or 18 which may be coextensive, as well as walls 20 and 22 which join to form a junction with ceiling members 18 or 16 as configured. The ceilings 55 and walls 13 may have junctions 17 and 19, for example, as well as junctions 21 and 23. The bays may also have heating elements 28 and 30. Typically steam is utilized to heat the bays. The bays can be in tandem where the heating elements extend along just one shared wall, or the bays may be singular, or multiple bays may be utilized according to an embodiment of the disclosure. In accordance with example implementations, the bays can include a baffle or a pair of baffles 32 and 36, for example, or 38 and 34. These baffles can extend from about a junction 17, 19, 21 or 23 along each of the walls 20 or 28, 30 or 32, towards the floor, extending either from the ceiling or proximate the ceiling as desirable. These baffles can be constructed of a heat bearable material such as a rubber elastomer material, and these baffles can extend downwardly from the ceiling towards a floor of the kiln.

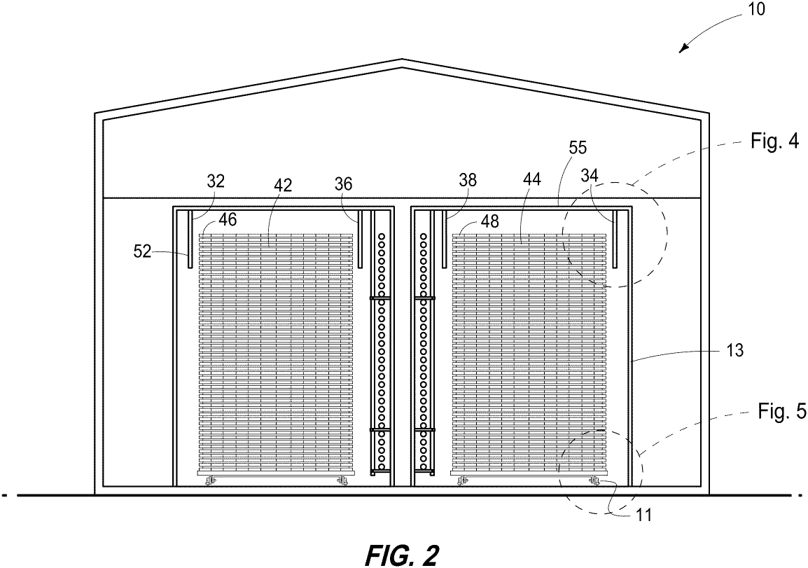

Referring next to FIG. 2, housing 10 may have material 42 to be dried therein. As shown, the material to be dried may be in pieces and be constructed of courses, with each course piece being separated from one another. The baffles 32 and 36 can extend from upward portion or junction 17 towards along the side of the material to be dried; at least three courses down from above the top of the material to be dried. In accordance with example implementations, the material to be dried can be lumber, for example.

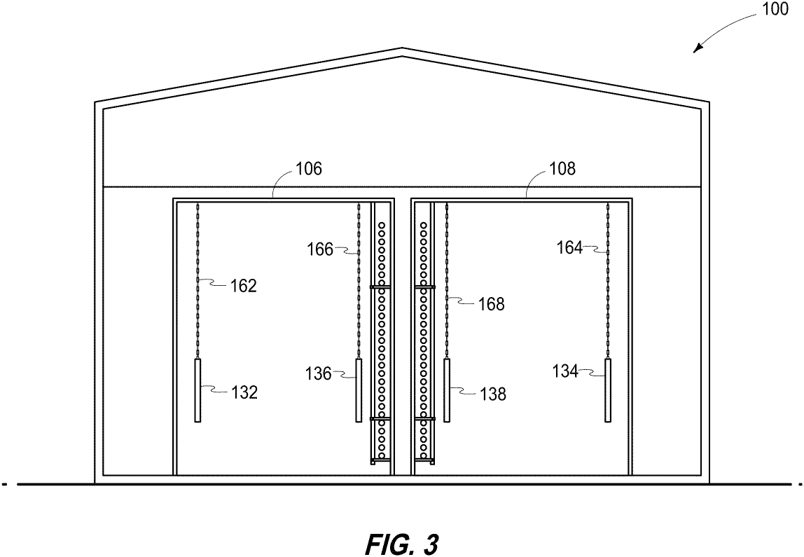

Referring next to FIG. 3, a retrofit is shown wherein existing kiln housing 100 has two bays, and the bays are retrofit with baffles according to embodiments of the present disclosure. In accordance with example implementations, the baffles can be extended or laid out along the floor opposing one another, and then strung into place along chains or cables or other heat resistant materials. These baffles 132 and 136 or 138 and 134 can be extended towards the ceiling to a point about a junction of the ceiling and the walls utilizing suspending mechanisms 162, 166, 168, and 164 to be associated with ceilings 106 and 108.

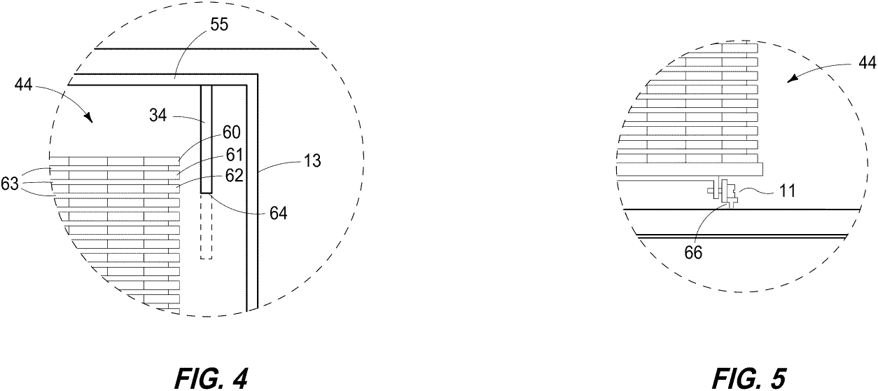

Referring next to FIG. 4, a detailed view of a portion of FIG. 2 is provided. In this view top course 60 is shown. In accordance with accepted kilning terminology, lumber is provided stacked with each level of lumber being separated from neighboring levels by a spacer material. Each level is commonly referred to as a course of lumber. In FIG. 4 for example, the top level or course of lumber 60 is separated from the next lower course 61 which is separated from the next lower course 62. Each of these courses are separated from one another by materials 63. Materials 63 can be other forms of wood, typically scrap wood. As can be seen baffle 34 can extend from kiln ceiling 55 to a termination 64 that is equivalent to at least the top 3 courses of stack 44.

Referring next to FIG. 5, a detailed view of a portion of FIG. 2 which shows wheels 66 supporting a platform and stack 44 is provided. In accordance with example implementations, each stack can be supported by as many as four wheels which are configured for rolling stack 44 to/from the kiln.

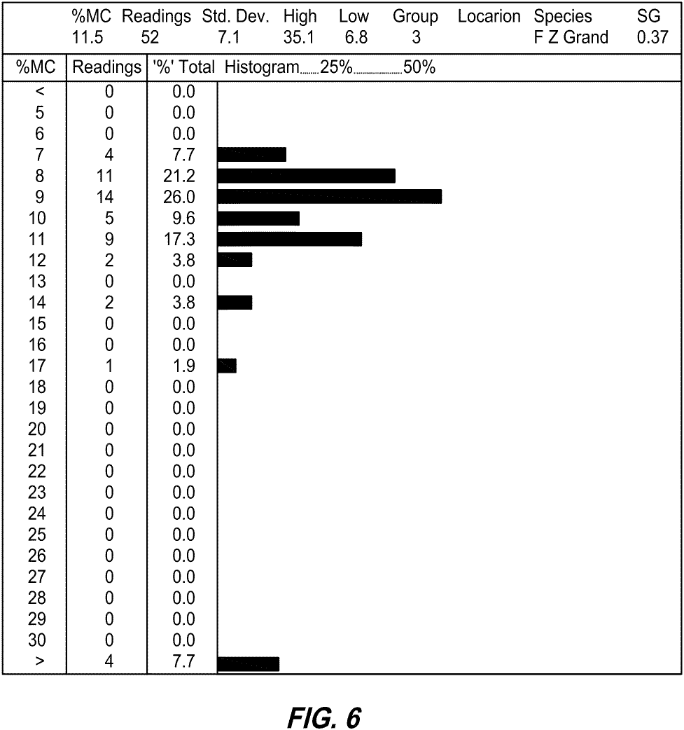

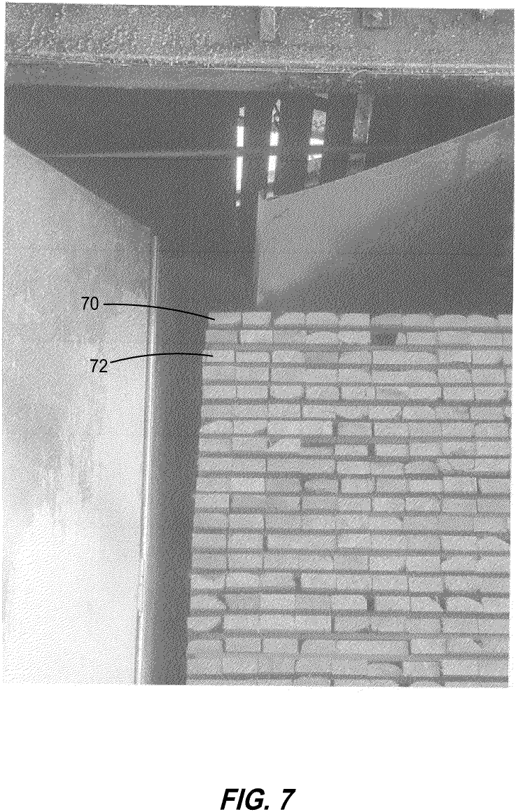

Referring next to FIGS. 6-11, data and kiln/stack/baffle configurations are provided that demonstrate the surprising result of achieving near 19% MC. Referring first to FIGS. 6 and 7, data is provided that shows an average moisture content of 11.5 % (far too dry to be saleable) when kilning lumber without baffle(s) as depicted in FIG. 7. As shown there is no baffle along the edge of the stack between courses 70 (top) and 72 (3^{rd} from top).

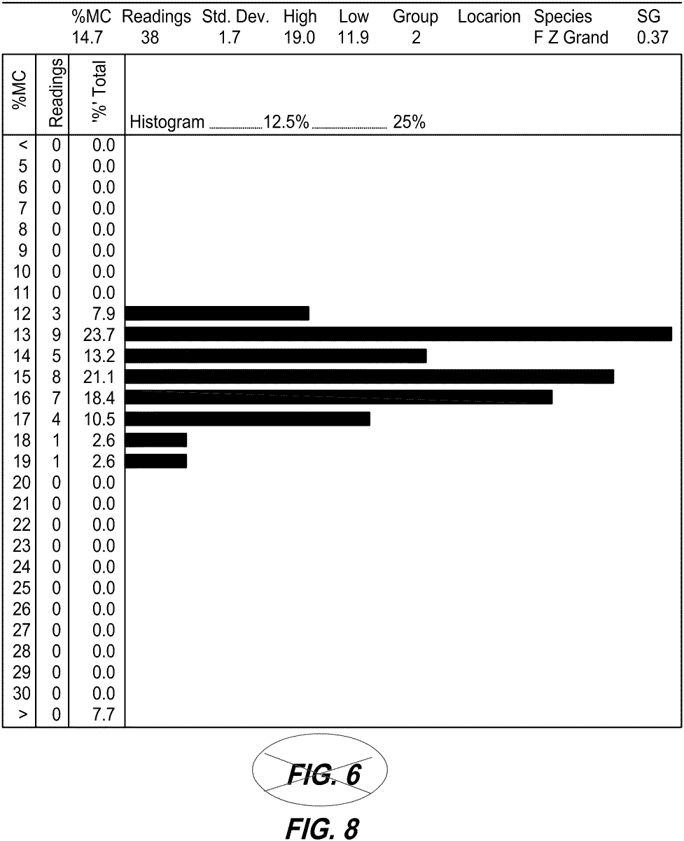

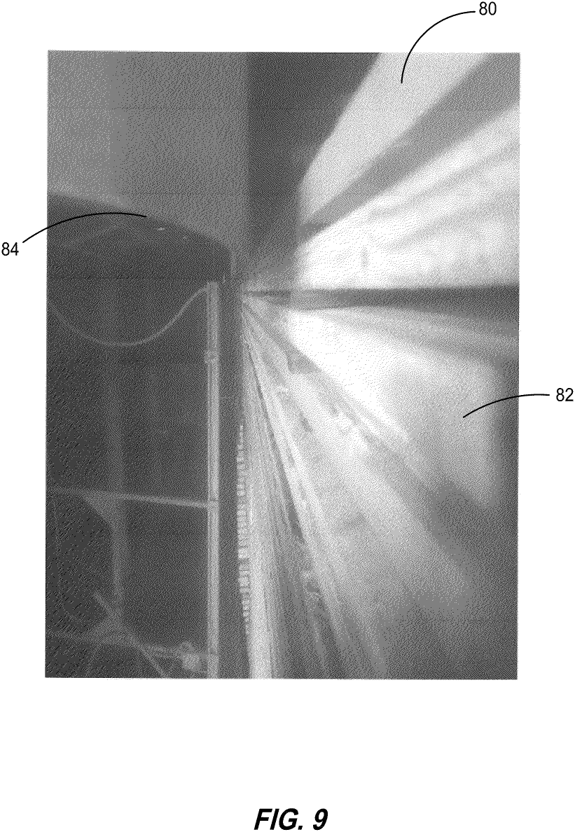

Referring next to FIGS. 8 and 9, data is provided that shows an average moisture content of 14.7 % (still too dry to be saleable) when kilning lumber with baffle(s) as depicted in FIG. 9. As shown there is a baffle having terminus 84 along the edge of the stack between course 80 (top) but above course 82 (3^{rd} from top).

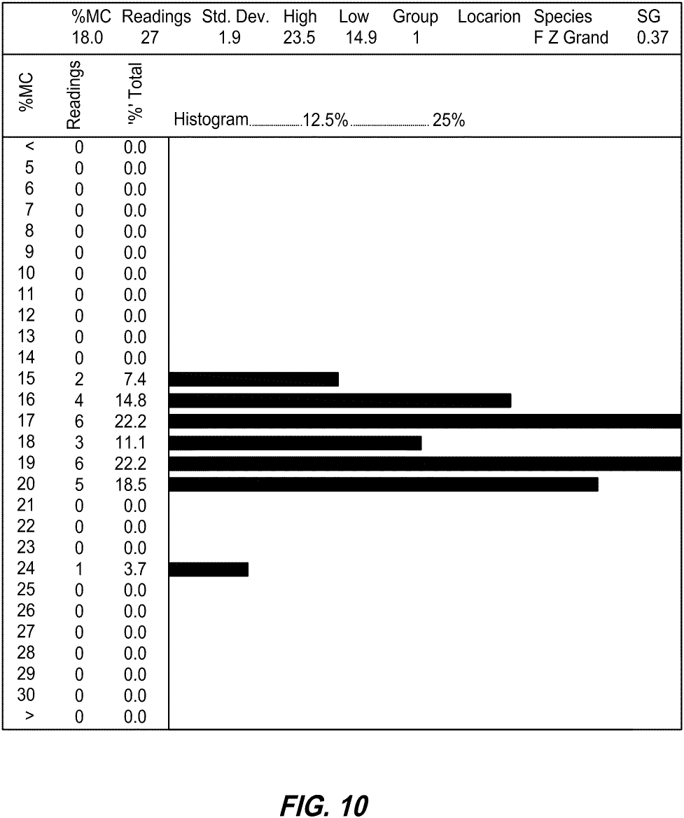

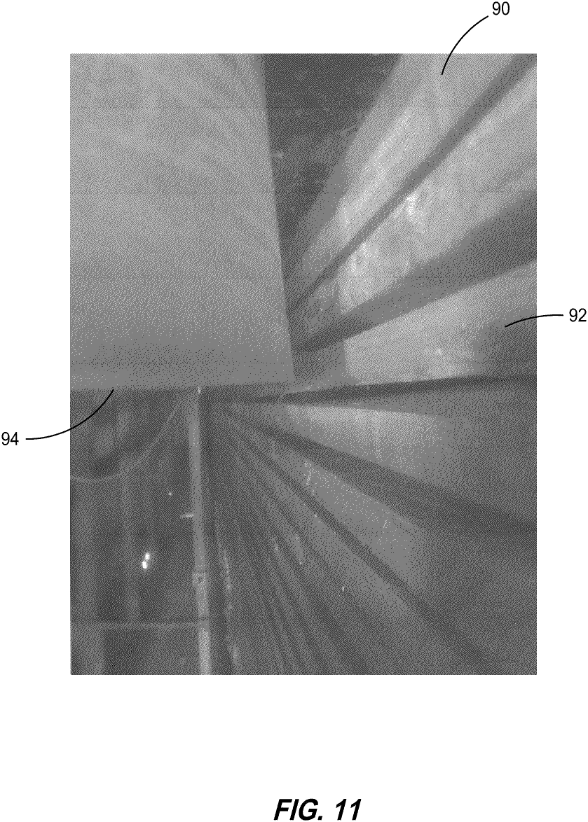

Referring next to FIGS. 10 and 11, data is provided that shows an average moisture content of 18.0 % (sufficiently moist to be saleable) when kilning lumber with baffle(s) as depicted in FIG. 11. As shown there is a baffle having terminus 94 along the edge of the stack between course 90 (top) but above the bottom of course 92 (3^{rd} from top).

In summary as shown in Table 1 below, when the terminus of the lateral baffle is at least to the third course, the moisture content of the lumber is saleable.

TABLE 1

Lumber Moisture Content with/without baffles

| | |
|---|---|
| No Baffle | 11.5% |
| Baffle to 1^{st} course | 14.7% |
| Baffle to 3^{rd} course | 18.0% |

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

1. A lumber drying kiln comprising:
a ceiling member supported by opposing continuous wall members;
stacked lumber to be kilned within the kiln, the stacked lumber being under the ceiling member and between the opposing continuous wall members, wherein the stacked lumber is arranged in courses, with each course vertically spaced apart from one another from a top of the stacked lumber to a bottom of the stacked lumber;
at least one heating source lateral of the stacked lumber; and
at least one rubber baffle lateral of the stacked lumber, the at least one rubber baffle extending vertically from the ceiling between the stacked lumber and at least one of the opposing continuous wall members to at least three courses below the top of the stacked lumber and exposing the heating source to the stacked lumber below the at least third course.

2. The lumber drying kiln of claim 1 wherein at least one of the continuous wall members supports the heating source.

3. The lumber drying kiln of claim 1 wherein the baffle resides between the stacked lumber and the continuous wall member.

4. The lumber drying kiln of claim 1 wherein the at least one baffle extends the length of the kiln.

5. The lumber drying kiln of claim 1 wherein the ceiling member and opposing walls define at least one bay of a multi-bay complex of drying kilns, wherein pairs of bays share a wall and that wall supports the heating source.

6. The lumber drying kiln of claim 1 further comprising a void free of baffle material between below the top three courses of stacked lumber and the continuous wall.

7. The lumber drying kiln of claim 1 further comprising a pair of complimentary baffles extending vertically from about a junction of the wall and ceiling.

8. The lumber drying kiln of claim 1 wherein at least one of the opposing walls supports a kiln heating source.

9. The lumber drying kiln of claim 8 wherein the baffles comprise rubber.

10. The lumber drying kiln of claim 9 wherein the rubber is high temperature rubber.

11. The lumber drying kiln of claim 10 wherein the high temperature rubber comprises silicone.

12. The lumber drying kiln of claim 1 wherein the baffle is spaced apart from one or both of the wall and/or material to be dried.

13. A method for drying material within a drying kiln, the method comprising:
providing a drying kiln comprising a ceiling member supported by opposing continuous wall members and at least one heat source lateral of wherein stacked lumber is to be received and dried within the kiln;
providing stacked lumber to be kilned to within the kiln, the stacked lumber being under the ceiling member and between the opposing continuous wall members, wherein the stacked lumber is arranged in courses, with each course vertically spaced apart from one another from a top of the stacked lumber to a bottom of the stacked lumber;
providing at least one rubber baffle lateral of where the stacked lumber is received, the at least one rubber baffle extending vertically from the ceiling between where the stacked lumber is received and at least one of the opposing continuous wall members to at least three courses below the top of the stacked lumber and exposing the heating source to the stacked lumber below the at least third course; and
drying the stacked lumber within the kiln while the at least one baffle hangs along the opposing wall of the kiln to at least three courses below the top of the stack of lumber.

14. The method of claim 13 wherein there are at least a pair of baffles bracketing the stack of lumber.

15. The method of claim 13 wherein air flow is provided within the kiln at a flow of about 1200 F/M, and the kiln is maintained at a temperature of from about 80° F. to about 240° F.

16. A method for retrofitting an existing drying kiln, the method comprising:
extending at least one baffle from about a junction of a wall and ceiling of the drying kiln, wherein the baffle extends about the length of the kiln; and
raising each of the baffles to about the junction from the ceiling.
